(19) United States
(12) Patent Application Publication
(10) Pub. No.: US 2020/0333802 A1
(43) Pub. Date: Oct. 22, 2020

(54) UNMANNED-DRIVE MOBILE MULTIFUNCTIONAL VEHICLE SYSTEM AND USING METHOD THEREOF

(71) Applicants: Ming Zhang, Guiyang (CN); Chuan Yu, Guiyang (CN)

(72) Inventors: Ming Zhang, Guiyang (CN); Chuan Yu, Guiyang (CN)

(21) Appl. No.: 16/836,961

(22) Filed: Apr. 1, 2020

(30) Foreign Application Priority Data
Apr. 22, 2019 (CN) 201910325674.1

(51) Int. Cl. G05D 1/02; G05D 1/00; G06Q 10/10

(52) U.S. Cl. CPC G05D 1/0278; G05D 1/0257; B60R 16/033; G05D 1/0231; G06Q 10/1097; G05D 1/0088

(57) ABSTRACT

The invention disclosures an unmanned-drive mobile multifunctional vehicle system and using method thereof, comprising a server (1) connected with a remote scheduling module (2) and vehicle terminal respectively; the vehicle terminal comprises chassis and vehicle body, the chassis and the vehicle body are detachably connected; the chassis is provided with a chassis management system (3), the vehicle body is provided with a vehicle body separation system (4); the chassis management system (3) comprises an autopilot module (31) and a chassis wireless communication module (32); the vehicle body separation system (4) comprises a separation execution module (41) and a vehicle body wireless communication module (42); the autopilot module (31) comprises an Industrial Personal Computer (311), a laser radar (312), and a GPS module (313). The invention has advantages of saving manpower, good expansibility and saving resources.

### BACKGROUND OF THE INVENTION

### 1. Field of the Invention

The invention relates to the technical field of autonomous driving, in particular to an unmanned-drive mobile multifunctional vehicle system and using method thereof.

### 2. Background Art

Now with the intelligent and electric development in transportation field, some vehicles with special functions have came into people's view, such as mobile express delivery vehicles and mobile vending vehicles. At present, most of these operating vehicles require manual driving and have a single function, low intelligence, and require human involvement in operations, which increases labor costs.

### SUMMARY OF THE INVENTION

The invention aims to provide an unmanned-drive mobile multifunctional vehicle system and using method thereof. The invention has advantages of saving manpower, good expansibility and saving resources.

The technical schemes of the invention: an unmanned-drive mobile multifunctional vehicle system, comprising a server, the server is connected with a remote scheduling module and vehicle terminal respectively for communication; the vehicle terminal comprises chassis and vehicle body, the chassis and the vehicle body are detachably connected; the chassis is provided with a chassis management system, the vehicle body is provided with a vehicle body separation system; the chassis management system comprises an autopilot module and a chassis wireless communication module; the vehicle body separation system comprises a separation execution module and a vehicle body wireless communication module; the autopilot module comprises an Industrial Personal Computer, a laser radar, and a GPS module;

the remote scheduling module is used for realizing remote scheduling of the vehicle terminal;

the server is used for transmission, integration, distribution and storage processing of data between the remote scheduling module and the vehicle terminal;

the chassis management system is used for running management of the chassis;

the vehicle body separation system is used for separation between the vehicle body and the chassis;

in the chassis management system:

the chassis wireless communication module is used for data interaction between the chassis management system and the server,

the autopilot module is used for controlling the autopilot of the chassis;

in the vehicle body separation system:

the vehicle body wireless communication module is used for information interaction between the vehicle body separation system and the server,

the separation execution module is used for separating the vehicle body and the chassis;

in the autopilot module:

the Industrial Personal Computer is used for processing and decision-making on interactive data and transmitting the action commands to the corresponding chassis execution components to realize automatic driving,

the laser radar is used for collecting environmental data around the vehicle terminal and sending the environmental data to the Industrial Personal Computer for decision-making,

the GPS module is used for providing chassis position and matching the position on the map.

The aforementioned unmanned-drive mobile multifunctional vehicle system, wherein the chassis management system also comprises an energy management module used for management of charging/discharging, balance maintenance, battery status and battery early-warning of vehicle battery.

The aforementioned unmanned-drive mobile multifunctional vehicle system, wherein the autopilot module also comprises a camera module used for collecting road condition information, traffic signal information and pedestrian and vehicle information, and sending the collected information to the Industrial Personal Computer for decision making.

An using method of the aforementioned unmanned-drive mobile multifunctional vehicle system, comprising following steps:

a. the remote scheduling module scheduling the chassis through the server to transport the vehicle body, the autopilot module of the scheduled chassis controlling the chassis for automatic driving and transporting the vehicle body to the preset position;

b. after reaching the preset position, the autopilot module stopping running and feeding back the stop signal to the server;

c. the server sending the stop signal to the separation execution module of the vehicle body separation system through vehicle body wireless communication module;

d. after receiving the stop signal, the separation execution module carrying out the separation action between the vehicle body and the chassis, and feeding back the separation signal to the server thereafter; the server sending separation signal to the remote scheduling module;

e. after receiving the separation signal, the remote scheduling module commanding the autopilot module of the chassis to control the chassis to drive away from the vehicle body and scheduling the chassis to transport the next vehicle body.

An using method of the aforementioned unmanned-drive mobile multifunctional vehicle system, wherein in the step e, after the chassis driving away from the vehicle body, the energy management module calculating the maximum driving mileage according to the residual power information of the battery on the chassis; when the transport mileage of the next vehicle body is greater than the maximum driving mileage, the energy management module sending early-warning information to the server, the chassis stopping moving or driving to a charging station within the maximum driving mileage to charge, and the remote scheduling module scheduling another chassis for the transportation of the next vehicle body.

### Advantageous Effects

Compared to the prior art, the server of the invention is connected with a remote scheduling module and vehicle terminal respectively; the vehicle terminal comprise chassis and vehicle body, and the chassis and the vehicle body are detachably connected, the chassis is provided with a chassis management system, the vehicle body is provided with a vehicle body separation system; the chassis management system comprises an autopilot module and a chassis wireless communication module; the vehicle body separation system comprises a separation execution module and a vehicle body wireless communication module; according to the structure of the invention, the chassis and the vehicle body of the vehicle terminal are detachable, the vehicle body can be used as a carrier for different functions according to standardized design, such as retail cabin, express container cabin, mobile small fitness room, mobile beverage shop etc., and function thereof is highly scalable; various function cabins (vehicle bodies) can be automatically connected with the chassis, and with the function of autopilot, the chassis transporting cabins (vehicle bodies) with different functions to different destinations, the chassis and the cabins are separated after transporting, and the chassis is scheduled by the remote scheduling module after separation to process the transportation of the next cabin, thereby achieving the reuse of the chassis, saving resources and optimizing efficiency simultaneously, the chassis of the invention conduct remote scheduling through the remote scheduling module to achieve the unmanned-drive automatic movement, thereby the automatic mobile multifunctional vehicle system can not only save drivers and reduce the labor cost, but also can be integrated into the city traffic network, can be unified management and scheduling, which may effectively improve the traffic operation efficiency, and meet the requirements of urban intelligent development.

The energy management module of the invention can calculate the maximum driving mileage according to the residual power information of the battery on the chassis, and compare the maximum driving mileage to the transport mileage to confirm the next operation of the chassis; through this method, the scientific scheduling of the chassis by the remote scheduling module is realized, and the operating efficiency and reliability of the system can be further improved.

In summary, the invention has advantages of saving manpower, good expansibility and saving resources.

### BRIEF DESCRIPTION OF THE DRAWINGS

FIG. 1 is a schematic diagram showing the system structure of the invention.

In the accompanying drawings, 1 refers to server, 2 refers to remote scheduling module, 3 refers to chassis management system, 31 refers to autopilot module, 311 refers to Industrial Personal Computer, 312 laser radar, 313 refers to GPS module, 314 refers to camera module, 32 refers to chassis wireless communication module, 33 refers to energy management module, 4 refers to vehicle body separation system, 41 refers to separation execution module, 42 refers to vehicle body wireless communication module.

### DETAILED DESCRIPTION OF THE PREFERRED EMBODIMENTS

The following is a further description of the invention with reference to the accompanying drawings and embodiments, but not a basis for limiting the invention.

### Embodiment 1

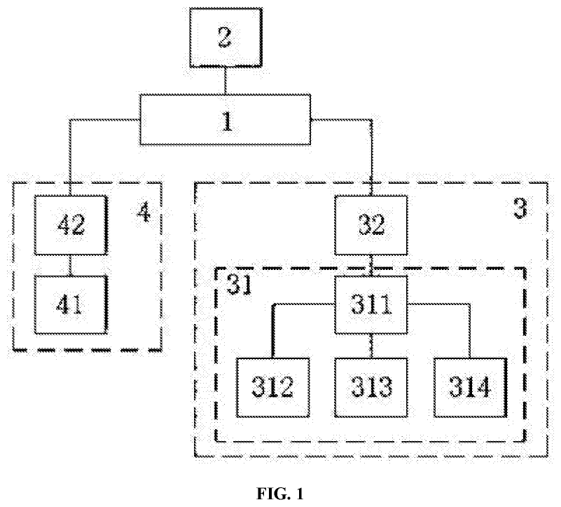

As shown in FIG. 1, an unmanned-drive mobile multifunctional vehicle system, comprising a server 1, the server 1 is connected with a remote scheduling module 2 and vehicle terminal respectively for communication; the vehicle terminal comprises chassis and vehicle body, the chassis and the vehicle body are detachably connected (the detachable connection structure between the chassis and the vehicle, can be adopted conventional detachable structure); the chassis is provided with a chassis management system 3, the vehicle body is provided with a vehicle body separation system 4; the chassis management system 3 comprises an autopilot module 31 and a chassis wireless communication module 32; the vehicle body separation system 4 comprises a separation execution module 41 and a vehicle body wireless communication module 42; the autopilot module 31 comprises an Industrial Personal Computer 311, a laser radar 312, and a GPS module 313;

the remote scheduling module 2 is used for realizing remote scheduling of the vehicle terminal; in particular, for obtaining the vehicle position in real time by the GPS module 313 to control the autopilot module 31, realize remote scheduling and improve the operation efficiency. The remote scheduling module 2 is used for: \textcircled{1} tracking and location monitoring the vehicle terminal, tracking whether the vehicle terminal is out-of-limit, and tracking the battery status, vehicle operation status and real-time earnings, which are all displayed on the electronic screen to facilitate the background intuitive understanding on vehicle status information; \textcircled{2} commanding, scheduling and integrated management, according to the fact data fed back by the vehicle terminal, manual participation can be involved into the operational planning of the vehicle terminal, for example, there is an increase in pedestrian volume in an area, and there are fewer vehicles in this area which cannot meet the demand, thereby it is necessary to intelligently schedule the nearest vehicle terminal; \textcircled{3} statistical analysis and track playback, the remote scheduling module 2 can form relevant business statistics reports for the vehicle body in the system, and playback vehicle running track stored in data for a specified period of time, which may facilitate post analysis and processing.

The server 1 is used for transmission, integration, distribution and storage processing of data between the remote scheduling module 2 and the vehicle terminal;

the chassis management system 3 is used for running management of the chassis;

the vehicle body separation system 4 is used for separation between the vehicle body and the chassis;

in the chassis management system 3:

the chassis wireless communication module 32 is used for data interaction between the chassis management system 3 and the server 1,

the autopilot module 31 is used for controlling the autopilot of the chassis; the system structure of the autopilot module 31 can be adopted conventional unmanned driving system, such as Autoware, Apollo of Baidu Group or unmanned system of Google,

in the vehicle body separation system 4:

the vehicle body wireless communication module 42 is used for information interaction between the vehicle body separation system 4 and the server 1,

the separation execution module 41 is used for separating the vehicle body and the chassis; the separation execution module 41 can be adopted conventional hydraulic actuating mechanism, the execution of the separation action of the hydraulic actuating mechanism is as following: after receiving the stop signal, the hydraulic cylinder of the hydraulic actuating mechanism is extended to support on the ground, the vehicle body is raised up to separate the vehicle body from the chassis in the vertical direction, and then the chassis can be driven away from below the vehicle body;

in the autopilot module 31:

the Industrial Personal Computer 311 is used for processing and decision-making on interactive data and transmitting the action commands to the corresponding chassis execution components (such as vehicle wheels or steering mechanism) to realize automatic driving; in particular, the Industrial Personal Computer 311 is mainly used for receiving environment data collected by the laser radar 312 and/or the camera module 314, after data processing, obtaining the relative distance, relative speed, angle and motion direction between the surrounding objects and the vehicle for the decision making of the Industrial Personal Computer 311; thereafter, the Industrial Personal Computer 311 transmitting the decisions (that is action commands that the vehicle needs to be executed) to the corresponding chassis execution components to realize automatic driving;

the laser radar 312 is used for collecting environmental data around the vehicle terminal and sending the environmental data to the Industrial Personal Computer 311 for decision-making, the environmental data involves pedestrian with special characteristics and surrounding vehicles; in particular, the laser radar 312 can scan the information around the vehicle in real time through the high-speed rotating laser wire harness to obtain the environmental data;

the GPS module 313 is used for providing chassis position and matching the position on the map.

The aforementioned chassis management system 3 also comprises an energy management module 33 used for management of charging/discharging, balance maintenance, battery status and battery early-warning of vehicle battery.

The aforementioned autopilot module 31 also comprises a camera module 314 used for collecting road condition information, traffic signal information and pedestrian and vehicle information, and sending the collected information to the Industrial Personal Computer 311 for decision making.

An using method of the aforementioned unmanned-drive mobile multifunctional vehicle system, comprising following steps:

a. the remote scheduling module 2 scheduling the chassis through the server 1 to transport the vehicle body, the autopilot module 31 of the scheduled chassis controlling the chassis for automatic driving and transporting the vehicle body to the preset position; the remote scheduling module 2 is established communication with the server 1, and the server 1 is established communication with the autopilot module 31 through the chassis wireless communication module 32, and data interaction between the remote scheduling module 2 and the autopilot module 31 is established by the server 1 to realize the scheduling of chassis by remote scheduling module 2;

b. after reaching the preset position, the autopilot module 31 stopping running and feeding back the stop signal to the server 1;

c. the server 1 sending the stop signal to the separation execution module of the vehicle body separation system through vehicle body wireless communication module;

d. after receiving the stop signal, the separation execution module 41 carrying out the separation action between the vehicle body and the chassis, and feeding back the separation signal to the server 1 thereafter; the server 1 sending separation signal to the remote scheduling module 2;

e. after receiving the separation signal, the remote scheduling module 2 commanding the autopilot module 31 of the chassis to control the chassis to drive away from the vehicle body and scheduling the chassis to transport the next vehicle body.

In the aforementioned the step e, after the chassis driving away from the vehicle body, the energy management module 33 calculating the maximum driving mileage according to the residual power information of the battery on the chassis; when the transport mileage of the next vehicle body is greater than the maximum driving mileage, the energy management module 33 sending early-warning information to the server 1, the chassis stopping moving or driving to a charging station within the maximum driving mileage to charge, and the remote scheduling module 2 scheduling another chassis for the transportation of the next vehicle body. Through this method, the scientific scheduling of the chassis by the remote scheduling module is realized, and the operating efficiency and reliability of the system can be further improved.

1. An unmanned-drive mobile multifunctional vehicle system, comprising a server (1), the server (1) is connected with a remote scheduling module (2) and vehicle terminal respectively for communication; the vehicle terminal comprises chassis and vehicle body, the chassis and the vehicle body are detachably connected; the chassis is provided with a chassis management system (3), the vehicle body is provided with a vehicle body separation system (4); the chassis management system (3) comprises an autopilot module (31) and a chassis wireless communication module (32); the vehicle body separation system (4) comprises a separation execution module (41) and a vehicle body wireless communication module (42); the autopilot module (31) comprises an Industrial Personal Computer (311), a laser radar (312), and a GPS module (313); the remote scheduling module (2) is used for realizing remote scheduling of the vehicle terminal; the server (1) is used for transmission, integration, distribution and storage processing of data between the remote scheduling module (2) and the vehicle terminal; the chassis management system (3) is used for running management of the chassis; the vehicle body separation system (4) is used for separation between the vehicle body and the chassis; in the chassis management system (3): the chassis wireless communication module (32) is used for data interaction between the chassis management system (3) and the server (1), and the autopilot module (31) is used for controlling the autopilot of the chassis; in the vehicle body separation system (4): the vehicle body wireless communication module (42) is used for information interaction between the vehicle body separation system (4) and the server (1), and the separation execution module (41) is used for separating the vehicle body and the chassis; in the autopilot module (31): the Industrial Personal Computer (311) is used for processing and decision-making on interactive data and transmitting the action commands to the corresponding chassis execution components to realize automatic driving, the laser radar (312) is used for collecting environmental data around the vehicle terminal and sending the environmental data to the Industrial Personal Computer (311) for decision-making, the GPS module (313) is used for providing chassis position and matching the position on the map.

2. The unmanned-drive mobile multifunctional vehicle system of claim 1, wherein the chassis management system (3) also comprises an energy management module (33) used for management of charging/discharging, balance maintenance, battery status and battery early-warning of vehicle battery.

3. The unmanned-drive mobile multifunctional vehicle system of claim 1, wherein the autopilot module (31) also comprises a camera module (314) used for collecting road condition information, traffic signal information and pedestrian and vehicle information, and sending the collected information to the Industrial Personal Computer (311) for decision making.

4. An using method of the unmanned-drive mobile multifunctional vehicle system, comprising following steps: a. the remote scheduling module (2) scheduling the chassis through the server (1) to transport the vehicle body, the autopilot module (31) of the scheduled chassis controlling the chassis for automatic driving and transporting the vehicle body to the preset position; b. after reaching the preset position, the autopilot module (31) stopping running and feeding back the stop signal to the server (1); c. the server (1) sending the stop signal to the separation execution module (41) of the vehicle body separation system (4) through vehicle body wireless communication module (42); d. after receiving the stop signal, the separation execution module (41) carrying out the separation action between the vehicle body and the chassis, and feeding back the separation signal to the server (1) thereafter; the server (1) sending separation signal to the remote scheduling module (2); e. after receiving the separation signal, the remote scheduling module (2) commanding the autopilot module (31) of the chassis to control the chassis to drive away from the vehicle body and scheduling the chassis to transport the next vehicle body.

5. The using method of the unmanned-drive mobile multifunctional vehicle system of claim 4, wherein in the step e, after the chassis driving away from the vehicle body, the energy management module (33) calculating the maximum driving mileage according to the residual power information of the battery on the chassis; when the transport mileage of the next vehicle body is greater than the maximum driving mileage, the energy management module (33) sending early-warning information to the server (1), the chassis stopping moving or driving to a charging station within the maximum driving mileage to charge, and the remote scheduling module (2) scheduling another chassis for the transportation of the next vehicle body.
